(19) United States
(12) Patent Application Publication
(10) Pub. No.: US 2008/0198940 A1
(43) Pub. Date: Aug. 21, 2008

(54) SYSTEM AND METHOD FOR DATA TRANSMISSION BETWEEN A TRANSMITTER AND A RECEIVER ACROSS A TRANSMISSION LINE

(75) Inventors: Gangolf Hirtz, Kronach (DE); Wilhelm Seel, Michelau (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/028,331

(22) Filed: Feb. 8, 2008

(30) Foreign Application Priority Data
Feb. 16, 2007 (DE) 102007 007 838.4

(51) Int. Cl. H04B 3/00

(52) U.S. Cl. 375/257

(57) ABSTRACT

A receiver transmits data to a driver over a differential pair line, during blanking periods, in a system employing low voltage differential signaling.

### CROSS-REFERENCE TO RELATED APPLICATIONS

This application claims foreign priority benefits under 35 U.S.C. §119(a)-(d) to DE 10 2007 007 838.4, filed Feb. 16, 2007, which is hereby incorporated by reference in its entirety.

### BACKGROUND

1. Field of the Invention

The invention relates to systems and methods for data transmission between a transmitter and a receiver across a transmission line.

2. Discussion

Low voltage differential signaling (LVDS) may achieve high speeds over data lines, e.g., twisted-pair copper cables, and is an interface standard for high-speed data transmission. The American National Standards Institute/Telecommunications Industry Association/Electronic Industries Alliance-644-1995 standard specifies the physical layer as an electronic interface.

### SUMMARY

Embodiments of the invention may take the form of a system for data transmission. The system includes a transmission line including first and second conductors each configured to carry current driven by a current source. The system also includes a driver, including a current source, electrically connected with the transmission line. The driver selectively passes current from the current source to one of the conductors during an active transmission period. A voltage differential exists between the conductors during the active transmission period. The system further includes a receiver, including a termination resistance, electrically connected with the transmission line. The receiver, transmission line, and driver selectively form a continuous electrical path for current to travel from the current source to the termination resistance across one of the conductors, and from the termination resistance back to the driver across the other of the conductors. The receiver senses a polarity of a voltage across the termination resistance during the active transmission period and transmits data across the transmission line to the driver during a quiet transmission period.

Embodiments of the invention may take the form of a low voltage differential signaling system for data transmission. The system includes a transmission line including first and second conductors and a driver electrically connected with the transmission line. The system also includes a receiver electrically connected with the transmission line. The driver transmits information across the transmission line to the receiver, during an active period, via low voltage differential signaling. The receiver transmits information across the transmission line to the driver, during a quiet period, by selectively pulling a voltage of at least one of the conductors such that it is substantially equal to a voltage of the other of the conductors.

Embodiments of the invention may take the form of a method for transmitting data between a receiver and a transmitter across a transmission line including first and second conductors. The method includes selectively transmitting data from the transmitter across the transmission line to the receiver via low voltage differential signaling during an active period. The method also includes selectively pulling, at the receiver, a voltage of at least one of the conductors such that it is substantially equal to a voltage of the other of the conductors during a quiet period. The method further includes outputting a first voltage, at the driver, if a voltage of the first conductor is substantially equal to a voltage of the second conductor thereby transmitting data from the receiver across the transmission line to the driver.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic diagram of an equivalent system for data transmission via low voltage differential signaling;

FIG. 2 is an environmental view of the control unit and display that communicate via low voltage differential signaling showing that the control unit is remote from the display; and

FIG. 3 is a plot of logic gate output during a period of time showing the receiver transmitting data to the transmitter during the blanking period.

### DETAILED DESCRIPTION

In some embodiments, a differential driver with a current source that limits current output and a switch box that steers current through a resistor of a high-impedance differential receiver via transmission lines is provided. The differential driver produces odd-mode transmission, e.g., equal and opposite current flow in the transmission lines. The high-impedance differential receiver detects differential signals and amplifies them into standard logic levels. The current delivered to the resistor over one of the transmission lines returns to the driver over the other of the transmission lines.

The above described configuration may result in low electromagnetic interference (EMI) and may allow rejection of common-mode noise of up to, for example, ±1 V. If the current source is configured to limit current spikes, data rates of 1.5 Gbps are possible without substantial increases in power dissipation. Furthermore, the signal may have a driver offset of 1.2 V, and the receiver may accept an input range of ground to 2.4 V.

In other embodiments, a transmitter may selectively pass a current, e.g., 3.5 mA, into one of a twisted-pair of wires. The current then passes through a resistor, e.g., 100Ω, at a receiving end. The current then returns in the opposite direction along the other of the twisted-pair of wires. The receiver senses the polarity of the voltage across the resistor to determine a logic level, e.g., 1 or 0.

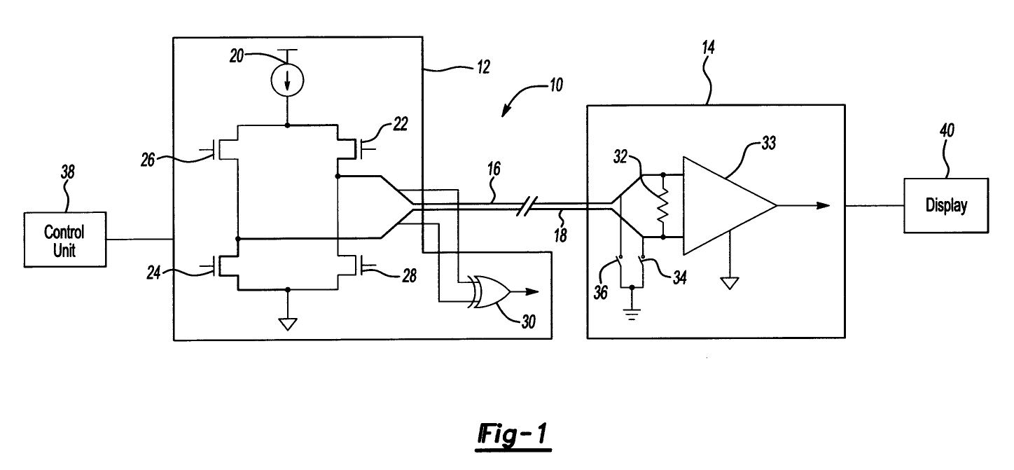

FIG. 1 is a schematic diagram of an equivalent system 10 for data transmission via low voltage differential signaling. System 10 includes transmitter 12, receiver 14, and differential pair lines 16, 18. Transmitter 12 includes current driver 20, switches 22, 24, 26, 28, e.g., field effect transistors, and logic gate 30, e.g., XOR logic gate or NAND gates configured to act as an XOR gate. Receiver 14 includes resistance 32, amplifier 33, and switches 34, 36.

Control unit 38 and display 40 are electrically connected with transmitter 12 and receiver 14 respectively. Control unit 38 is configured to selectively open and/or close switches 22, 24, 26, 28. Display 40 is configured to selectively open or close switches 34, 36. Display 40, for example, may receive signals from a remote control device (not shown). The information contained within those signals may be transmitted from display 40 to control unit 38 via lines 16, 18 through the selective opening and/or closing of switches 34, 36 as will be explained below.

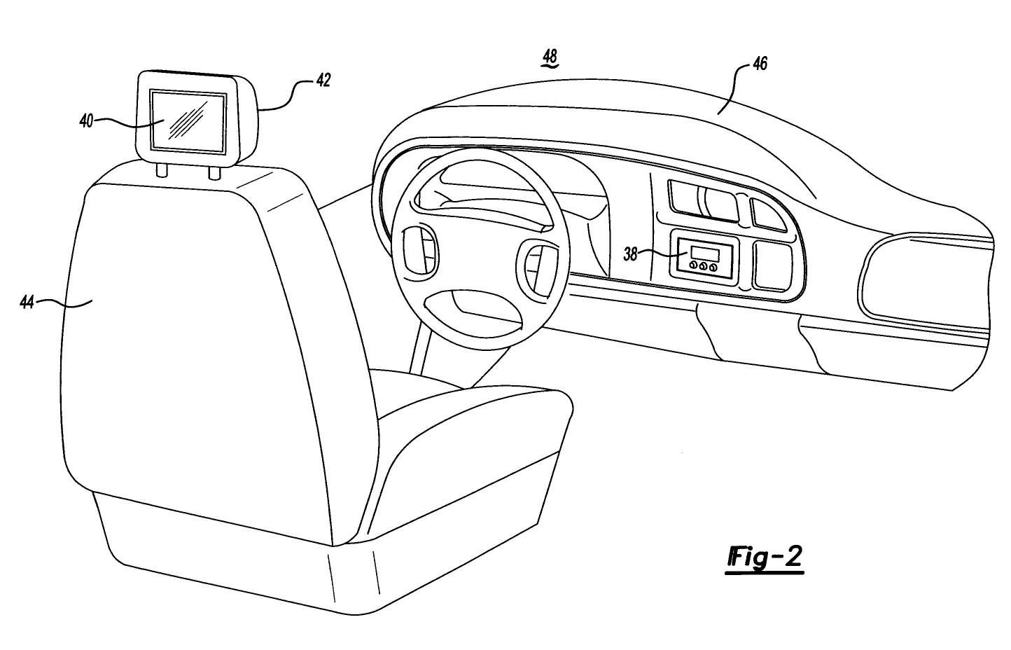

FIG. 2 is an environmental view of control unit 38 and display 40, which communicate via low voltage differential signaling, and shows that control unit 38 is remote from display 40. Display 40 may be mounted in headrest 42 of seat 44 and control unit 38 may be mounted in a dash board 46 of vehicle 48. In alternative embodiments, display 40 and headrest 42 may be mounted elsewhere, e.g., cabin roof and steering wheel respectively.

LVDS transmission may be used for high data rate transmission of audio/video (A/V) signals. The transmission of A/V signals normally includes horizontal and vertical blanking periods. During these blanking periods, A/V information is not being transmitted. As explained below, system 10 is configured to transmit information from receiver 14 to transmitter 12 via differential lines 16, 18 during these blanking periods.

During data transmission from transmitter 12 to receiver 14, switches 34, 36 are open. Control unit 38 may selectively open and close switching pairs 22, 24 and 26, 28 to drive current into either of differential pair lines 16, 18. If switches 22, 24 are closed and switches 26, 28 are open, current will travel from current driver 20 into line 16, across resistance 32, and back to transmitter 12 across line 18. Amplifier 33 may have a high input impedance such that most of the current flowing from transmitter 12 to receiver 14 will travel across resistance 32. If switches 26, 28 are closed and switches 22, 24 are open, current will flow in the opposite direction from that described above. Receiver 14 is configured to sense the direction of current flow using conventional techniques such that, for example, current flow in one direction is the equivalent of a logical 1 while current flow in the opposite direction is the equivalent of a logical 0. Logic gate 30 will output a voltage high, e.g., a digital 1, during the operation of system 10 as described above.

As explained above, FIG. 1 is a an equivalent system for LVDS transmission. Other circuit topologies, e.g., multi-resistor, multi-point, etc. are also contemplated. Furthermore, other applications, e.g., stackable hubs for data communications, peripherals such as copy machines, etc., are also contemplated.

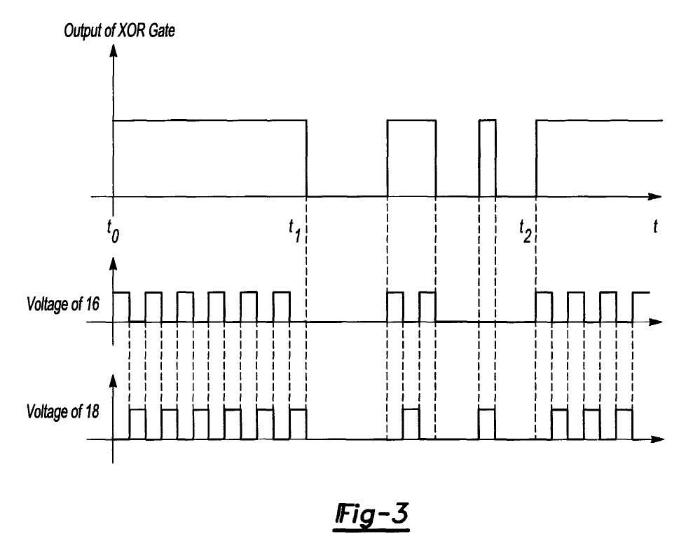

FIG. 3 is a plot of the output of logic gate 30 during period of time t and shows receiver 14 transmitting data to transmitter 12 during a blanking period. From time period t₀ to t₁, switches 34, 36 of receiver 14 are open and transmitter 12 transmits information to receiver 14 as described above. t₁ indicates the start of a blanking period. For the purposes of this example, this blanking period will last from t₁ to t₂. The duration and frequency of such blanking periods are determined by conventional protocols used for the LVDS transmission of data. Transmitter 12 and receiver 14 are thus synchronized such that each are aware of the times during which blanking periods begin and/or end.

Switches 34, 36 are selectively opened and closed during the blanking period such that differential pair lines 16, 18 are intermittently pulled to the same voltage, e.g., ground or a voltage high. Logic gate 30 will output a voltage low, e.g., a digital 0, if differential pair lines 16, 18 have the same voltage. Logic gate 30 will output a voltage high, e.g., a digital 1, if differential pair lines 16, 18 have different voltages. The output of logic gate 30, against a clocking sequence, during the blanking period allows, for example, receiver 14 to transmit consecutive digital 0's or 1's.

Digital information may be transmitted from receiver 14 to transmitter 12 over differential pair lines 16, 18 as opposed to an additional line between receiver 14 and transmitter 12. Control unit 38, or any other suitable device, may interpret the output of logic gate 30. Information may be transmitted from receiver 14 to transmitter 12 during all or some portion of any blanking period.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for data transmission comprising:
a transmission line including first and second conductors each configured to carry current driven by a current source;
a driver, including a current source, electrically connected with the transmission line, the driver being configured to selectively pass current from the current source to one of the conductors during an active transmission period wherein a voltage differential exists between the conductors during the active transmission period; and
a receiver, including a termination resistance, electrically connected with the transmission line, the receiver, transmission line, and driver being configured to selectively form a continuous electrical path for current to travel from the current source to the termination resistance across one of the conductors, and from the termination resistance back to the driver across the other of the conductors, the receiver being configured to sense a polarity of a voltage across the termination resistance during the active transmission period and transmit data across the transmission line to the driver during a quiet transmission period.

2. The system of claim 1 wherein the receiver is further configured to selectively pull, during the quiet transmission period, a voltage of at least one of the conductors such that it is substantially equal to a voltage of the other of the conductors.

3. The system of claim 2 wherein the receiver is further configured to selectively ground the conductors.

4. The system of claim 1 wherein the driver is further configured to output a first voltage if a voltage of the first conductor is substantially different than a voltage of the second conductor.

5. The system of claim 4 wherein the driver is further configured to output a second voltage if the voltage of the first conductor is substantially equal to the voltage of the second conductor.

6. The system of claim 5 wherein the driver further includes a logic gate electrically connected with the conductors and wherein the logic gate is configured to output the first and second voltages.

7. The system of claim 6 wherein the logic gate comprises an XOR logic gate.

8. The system of claim 6 wherein the logic gate comprises an NAND logic gate.

9. The system of claim 1 wherein the data is digital data.

10. A low voltage differential signaling system for data transmission comprising:
a transmission line including first and second conductors;
a driver electrically connected with the transmission line; and
a receiver electrically connected with the transmission line wherein the driver transmits information across the transmission line to the receiver, during an active period, via low voltage differential signaling and wherein the receiver transmits information across the transmission line to the driver, during a quiet period, by selectively pulling a voltage of at least one of the conductors such that it is substantially equal to a voltage of the other of the conductors.

11. The system of claim 10 wherein the receiver is further configured to selectively ground the conductors.

12. The system of claim 10 wherein the driver is further configured to output a first voltage if a voltage of the first conductor is substantially different than a voltage of the second conductor.

13. The system of claim 12 wherein the driver is further configured to output a second voltage if the voltage of the first conductor is substantially equal to the voltage of the second conductor.

14. A method for transmitting data between a receiver and a transmitter across a transmission line including first and second conductors, the method comprising:
selectively transmitting data from the transmitter across the transmission line to the receiver via low voltage differential signaling during an active period;
selectively pulling, at the receiver, a voltage of at least one of the conductors such that it is substantially equal to a voltage of the other of the conductors during a quiet period; and
outputting a first voltage, at the driver, if a voltage of the first conductor is substantially equal to a voltage of the second conductor thereby transmitting data from the receiver across the transmission line to the driver.

15. The method of claim 14 further comprising outputting a second voltage, at the driver, if the voltage of the first conductor is substantially different than the voltage of the second conductor.

16. The method of claim 15 wherein the first voltage is less than the second voltage.

17. The method of claim 14 wherein the step of selectively pulling a voltage of at least one of the conductors comprises grounding the conductors.
